(19) United States
(12) Patent Application Publication
(10) Pub. No.: US 2008/0039251 A1
(43) Pub. Date: Feb. 14, 2008

(54) Method and apparatus for limiting the input torque of a belt-driven conical-pulley transmission having an integrated hydromechanical torque sensor

(75) Inventor: Hartmut Faust, Buhl (DE)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhl (DE)

(21) Appl. No.: 11/891,045

(22) Filed: Aug. 8, 2007

Related U.S. Application Data
(60) Provisional application No. 60/844,532, filed on Sep. 14, 2006.

(30) Foreign Application Priority Data
Aug. 9, 2006 (DE) 10 206 037 135.6

(51) Int. Cl. F16H 55/36

(52) U.S. Cl. 474/18

(57) ABSTRACT

A method and apparatus for limiting the input torque of a belt-driven conical-pulley transmission having a hydromechanical torque sensing device. The torque-sensing device is contained in the transmission power path that includes an input shaft of the transmission and an output shaft. The torque sensing device controls a contact pressure that acts between a conical disk pair of the transmission as a function of the position of an actuator whose position depends upon the torque that acts on the input shaft. The input torque is determined by detecting a torque value that is sensed by the torque-sensing device.

### BACKGROUND OF THE INVENTION

1. Field of the Invention

The present invention relates to a method for limiting the input torque of a belt-driven conical-pulley transmission having a hydromechanical torque sensor.

2. Description of the Related Art

Vehicle power trains in which the power of an internal combustion engine or some other drive motor is transmitted to the driven wheels through a transmission having a continuously variable transmission ratio, preferably a belt-driven conical-pulley transmission, have been employed increasingly in recent times because of their greater comfort and convenience, but also because of favorable degrees of efficiency and adaptability to largely varying conditions.

The basic components of a motor vehicle power train of that type is known from DE 42 34 294 A1, for example, and those components are among some of the components shown schematically in FIG. 2:

An internal combustion engine BKM is connected via a clutch K to a transmission G having a continuously variable transmission ratio. The output shaft of clutch K forms an input shaft I for the belt-driven conical-pulley transmission G, whose output shaft II drives the driven wheels of a motor vehicle via a differential (not shown).

Input shaft I includes a torque-sensing device D. Non-rotatably arranged on input shaft I is a disk pair 1, and non-rotatably arranged on output shaft II is a disk pair 2. Each disk pair includes an axially movable disk 1a and 2a, respectively, and an axially fixed disk 1b and 2b, respectively. An endless torque-transmitting means in the form of a chain 3 is provided between the two disk pairs 1 and 2 to transmit torque therebetween.

A force dependent on the transmission ratio is exerted on the axially movable output-side disk 2a by a disk spring 4, which is designed and installed in such a way that a higher force is exerted on chain 3 when it is located in the radially inner region of input-side disk pair 1, and a lesser force when it is located on input-side disk pair 1 in the larger diameter outer region of the disk pair.

Disk spring 4 has its radially inner regions supported against the axially movable disk 2a, and its radially outer region supported against an axially fixed component of a piston/cylinder unit 6 that is designated as piston 5, and that is accommodated in the fluid chamber 6a of that unit. The axially movable cylinder part is designated as 7, and is non-rotatably connected to axially movable disk 2a.

In the input-side disk pair 1, axially movable disk 1a is likewise connected to a circumferential, axially movable cylinder part 8 of an outer piston/cylinder unit 9, whose rotating but axially fixed piston part is in the form of an annular piston 10 to define therebetween a fluid chamber 9a.

Parallel to and radially inward of fluid chamber 9a of piston/cylinder unit 9 is a fluid chamber 11a of an inner piston/cylinder unit 11, whose cylinder part 12 is axially fixed and is non-rotatably connected to input shaft I, and is rigidly connected to piston 10 of the outer piston/cylinder unit 9. Piston 13 is axially movable but is non-rotatably connected to input shaft I and is rigidly connected to the cylinder part 8 of the outer piston/cylinder unit 9.

Input shaft I drives a pump 14, which is able to deliver a pressure medium into the fluid chamber 11a of the inner piston/cylinder unit 11 through a line 16 via a single-edge spool valve or 3/2 directional control valve 15, depending upon the desired or needed transmission ratio. Depending upon the position of valve 15, either pressure medium is pumped through line 16 into fluid chamber 11a, and thus chain 3 is shifted outwardly on the disk pair—corresponding to the force of disk spring 4—or by appropriate positioning of valve 15 pressure medium is returned through line 17 into an oil sump. A filter 18 is positioned in the pressure medium stream ahead of pump 14, and a pressure limiting valve 19 is situated between pump 14 and valve 15.

To produce a pressure dependent upon the torque transmitted by the transmission G, a pump 20 is provided downstream of filter 18. Pump 20 feeds fluid chamber 6a of piston/cylinder unit 6 of output-side conical disk pair 2 through a line 21 and feeds fluid chamber 9a of radially outer piston/cylinder unit 9 of input-side disk pair 1 through line 22. Another line 23 leads from line 22 into a pressure chamber 24a of torque sensing device D, which as a whole forms a valve controlled by transmission ratio and torque and transmits the torque directly from the output of the clutch K to the input-side disk pair 1. Torque sensing device D has an axially fixed cam disk 24b and an axially movable cam disk 24c, both having shaped approach ramps between which spreading elements 24d in the form of balls are situated.

Connected to a discharge opening 24e is a line 25, which extends to and lubricates chain 3 and the disks with the hydraulic medium that escapes through opening 24e. Depending upon the transmission ratio setting and the torque operating between disks 24b and 24c, discharge opening 24e is closed to a greater or lesser degree by disk 24c, which acts as a control piston, and thus a pressure corresponding to the transmission ratio and the existing torque is created in pressure chamber 24a, in lines 23, 22, and 21, and hence also in pressure chambers 9a and 6a. At the same time, as a result of the parallel connection of piston/cylinder units 11 and 9, the pressure dependent upon the transmission ratio and torque is added to the set pressure for the transmission ratio.

Instead of piston/cylinder unit 6 with disk spring 4, there could likewise be two piston/cylinder units provided on conical disk pair 2, which are similar in design, situation and effect to piston/cylinder units 9, 11 of input-side disk pair 1. The inner piston/cylinder unit would then take over the function of disk spring 4 and would be subjected to a corresponding pressure by a known four-edged spool valve to set the transmission ratio.

Numerous variants are known for the design of the above-described known arrangement, as shown, for example, in the identified German published application DE 42 34 294 A1.

The described power train is controlled in a known way by an electronic control unit 40, whose inputs 42 are connected to sensors for detecting relevant operating parameters for the operation of the drive train. For example, a sensor 44 can detect the speed of rotation of internal combustion engine BKM, a sensor 46 can detect the speed of rotation of input shaft 1, a sensor 48 can detect the speed of rotation of output shaft 11 of transmission G, a sensor 50 can detect the position of an accelerator pedal, a sensor 52 can detect the position of a gear selector switch, and so on.

Programs are stored in electronic control unit 40, corresponding to which actuators connected to outputs 43 of control unit 40 are actuated. The actuators include an actuator 54 for a power setting unit of the internal combustion engine, an actuator 55 for operating clutch K, and an actuator 56 for valve 15 to set the transmission ratio of transmission G. Actuator 56 in particular can be integrated into an automatic control unit that checks whether a target transmission ratio of the transmission, which is calculated in control unit 40, agrees with an actual transmission ratio determined by rotational speed sensors 46 and 48, and that adjusts the actual transmission ratio accordingly in the event of a deviation. The above-described known arrangement can likewise be modified in a known way in many aspects. For example, torque sensing device D, which is integrated into the transmission G in the described example, can be designed in such a way that the instantaneous transmission ratio is not taken into account continuously but in steps, and/or that the rotational speed is also taken into account. A simple design without the detection of the transmission ratio and of the rotational speed is also possible.

In practical operation, it has been found that in particular the variable speed drive unit, including conical disk pairs 1 and 2 and chain 3, but also the complete transmission including components that are not shown, must be protected from overloading, which can detract from the service life. Such overloads can be due to a large variety of influences, such as, for example, chip tuning of the control system for the internal combustion engine, as a result of which the internal combustion engine produces torques that exceed those originally intended. In addition, over-demands can arise because at predetermined load points overloads develop and/or create additional loads, for example in utility vehicles with very high retarding torques due to continuous braking at the engine or transmission input, or due to intermediate power take-offs having unknown torques.

An object of the present invention is to protect a belt-driven conical-pulley transmission, in particular the latter's variable speed drive unit, from unacceptably high loads.

### SUMMARY OF THE INVENTION

The object is with a method for limiting the input torque of a belt-driven conical-pulley transmission having a hydromechanical torque-sensing device. The torque sensing device is contained in the transmission path from an input shaft of the transmission to an output shaft, and controls a contact pressure acting between a conical disk pair as a function of the position of an actuator whose position depends on the torque acting on the input shaft. The input torque is determined by detecting a value determined by the torque-sensing device.

Because the input torque of the belt-driven conical-pulley transmission is derived directly from the torque detected by the torque sensing device, the actual input torque is currently available, so that it can be reliably limited to a predetermined value by suitably controlling a drive engine or a clutch, or even a contact pressure of the belt-driven conical-pulley transmission itself. With the exception of a sensor, additional components are not necessary.

The value set by the torque-sensing device, with which the input torque is determined, is preferably the contact pressure set by the torque-sensing device.

Advantageously, when determining the effective input torque a characteristic curve of the torque sensing device is taken into account, which gives the contact pressure as a function of the instantaneous transmission ratio of the belt-driven conical-pulley transmission.

The input torque of the belt-driven conical-pulley transmission is limited by preference to a value that is a function of operating parameters of the belt-driven conical-pulley transmission.

Furthermore, the method in accordance with the invention can be executed in such a way that the input torque is limited as a function of operating parameters of a drive train in which the belt-driven conical-pulley transmission is included.

The input torque can be limited, for example, by limiting the drive torque generated by a drive engine.

It is also possible to limit the input torque by limiting the torque that can be transmitted by a clutch connected upstream of or downstream from the belt-driven conical-pulley transmission.

The present invention also relates to apparatus for limiting the input torque of a belt-driven conical-pulley transmission having a torque sensing device, which torque sensing device is contained in the transmission path from an input shaft of the transmission to an output shaft. The torque sensing device controls a contact pressure acting between a conical disk pair as a function of the position of an actuator whose position depends on the torque acting on the input shaft. The apparatus includes a torque sensor for detecting a value set by the torque-sensing device, an actuator for setting the input torque of the belt-driven conical-pulley transmission, and an electronic control unit connected to the torque sensor and the actuator. The electronic control unit controls the actuator to set the input torque in such a way that the value detected by the torque sensor does not exceed a predetermined value.

Advantageously, the apparatus in accordance with the present invention includes additional sensors for detecting operating parameters of a drive train in which the belt-driven conical-pulley transmission is contained, wherein the performance characteristics indicate the maximum permissible input torque as a function of at least one of the operating parameters.

The apparatus in accordance with the invention can also include a readable memory chip for storing collected values of at least one operating parameter of a drive train that includes the belt-driven conical-pulley transmission.

### BRIEF DESCRIPTION OF THE DRAWINGS

The structure, operation, and advantages of the present invention will become further apparent upon consideration of the following description, taken in conjunction with the accompanying drawings in which:

FIG. 1 is a flow chart to explain an embodiment of a method in accordance with the present invention; and

FIG. 2 is a block diagram of an embodiment of a drive train having a belt-driven conical-pulley transmission.

### DESCRIPTION OF THE PREFERRED EMBODIMENTS

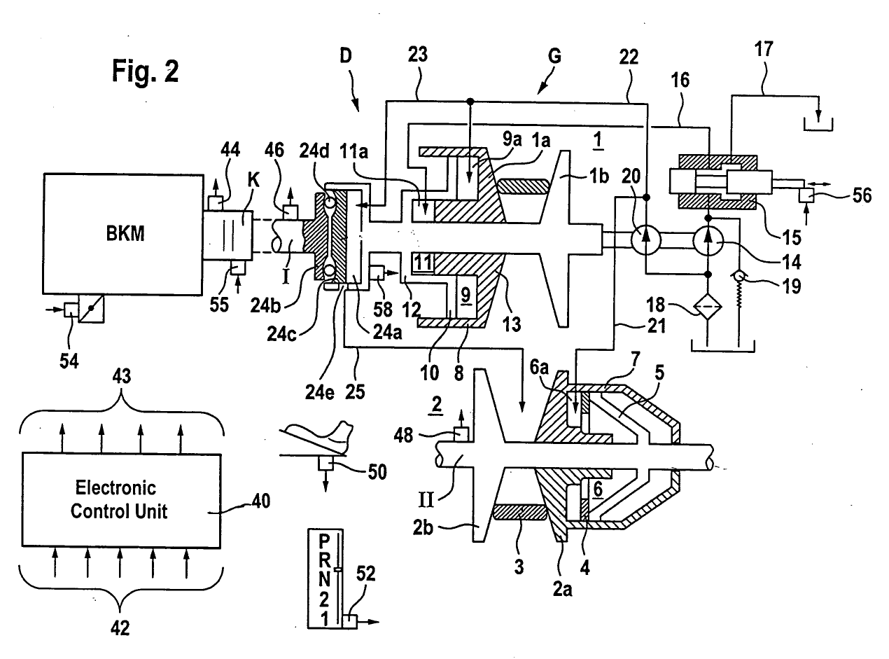

In accordance with the present invention, the basic components of a drive train described above and included FIG. 2 includes a pressure sensor 58 that detects the pressure prevailing in pressure chamber 24a of torque sensing device D, and is connected to an input of electronic control unit 40.

A performance characteristic of torque sensing device D that includes the torque transmitted by the torque sensing device is stored in control unit 40. The transmitted torque is equal to the input torque of the belt-driven conical-pulley transmission and is stored as a function of the pressure detected by pressure sensor 58, as well as possibly additional operating parameters of the belt-driven conical-pulley transmission, such as its transmission ratio (detectable by means of sensors 46 and 48), its rotational speed, and the like. Alternatively, the input torque of the belt-driven conical-pulley transmission transmitted by torque sensing device D can also be determined by direct detection of the position of cam disk 24c, which is detected by means of a suitable sensor and is theoretically correlated with the pressure in chamber 24a, wherein a constant discharge pressure of pump 20 is assumed.

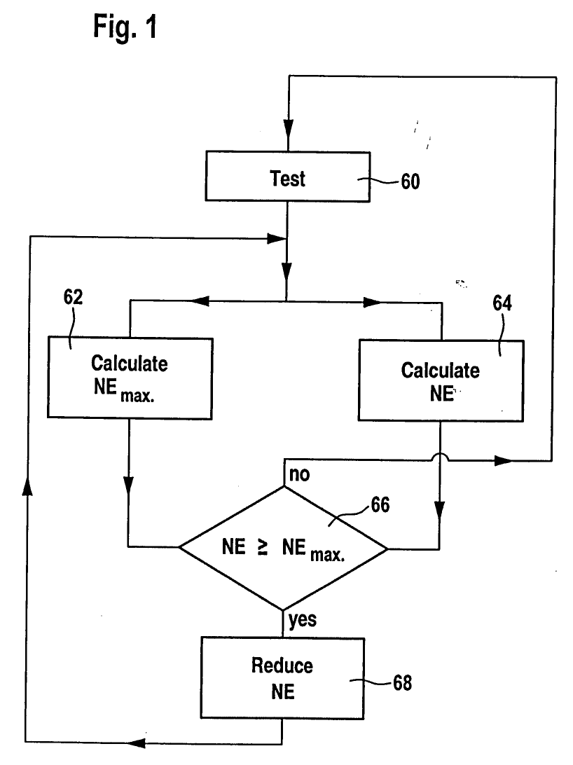

One form of execution of the method in accordance with the present invention is explained below on the basis of the flow chart shown in FIG. 1.

In step 60 a test program starts, as a function of operating parameters of the drive train, such as the transmission ratio of the transmission, determination of a high retarding torque or also of an unacceptably high temperature in the fluid circuit of the transmission, for example. In step 62 a maximum permissible torque NEₘₐₓ that can be transmitted by transmission G, possibly dependent on the operating conditions, is calculated. In step 64 the instantaneous torque transmitted by the transmission is calculated from the measurement of the pressure in pressure chamber 24a.

Step 66 checks whether NE is larger than or equal to NEₘₐₓ. If so, the torque transmitted by the transmission is reduced in step 68, for example by setting actuator 54 of the load control element of the internal combustion engine BKM appropriately, or by partially disengaging clutch K by means of its actuator 55.

The program then jumps again to steps 62 and 64, so that the check can be performed again in step 66 as to whether the conditions for reducing the input torque are still present. If the conditions are no longer present the program jumps to step 60, in which a check is again performed as to whether a test routine should be initiated.

It goes without saying that the program can be modified in various ways; for example, it can jump from step 68 to step 60.

The described invention is suitable for solving numerous problems that arise with belt-driven conical-pulley transmissions:

The stress on chain 3 with regard to plate force, bending of the rocker members, contacts between the rocker members themselves and between the rocker members and the conical surface of a disk, given the same input torque, is highest during underdrive transmission, i.e., when the small running radius of the chain is on the input disk pair. The circumferential force, or turning force, is high, the contact pressure is high, the pivot angle between the individual chain links is large, but the number of engaged rocker members is small. The same is true in overdrive in the disk pair on the output side, with the forces here being in fact smaller, but the run time portions are generally very large. It makes sense, therefore, in the range of underdrive and overdrive transmission ratio, to limit the permissible input torque under certain operating conditions, for example when certain rotational speeds are exceeded, or during long time periods at high torques.

In certain cases during so-called engine chip tuning, the torque information from the engine controller is incorrect, so that it cannot be used for limiting the torque. Torque ratings for which the transmission is designed can be exceeded during chip tuning. In accordance with the invention, such overruns are prevented by the limitation of the input torque.

In particular in utility vehicle applications, very high retarding torques can occur during engine braking; on the one hand these are readily measurable by means of the torque sensing device D, and on the other hand in accordance with the invention they can be promptly limited before damage occurs to the transmission.

With power-branched transmissions it is difficult to directly determine the torque transmitted by way of the variable speed drive unit, so that the determination of the transmitted torque in accordance with the invention will result in reliable readings and hence to reliable limitability.

Even a single overloading of the variable speed drive unit can result in its total failure if the chain runs beyond the outer diameter of the disk set because of high torques and high contact pressure. That can be reliably prevented by the present invention.

It can happen that the transmission runs for a long time at a constant transmission ratio and high torque, which can result in a danger to one region of the conical disks. In that case it is appropriate to at least briefly lower the transmitted torque.

Overall, the torque transmitted by the transmission can be limited in accordance with the invention in such a way that a constant contact pressure is achieved independent of the instantaneous transmission ratio, or a constant demand on the conical disks is achieved resulting from the running radius, the circumferential force, the contact pressure, the number of rocker members in contact with the disks, the bending angle of the link chain, and the like.

When a plurality of outputs, inputs, and/or braking devices are used, which jointly influence the total variable speed drive unit torque, the resulting changes in torque are reliably known by detecting the input torque by means of the torque sensing device.

In addition, the invention offers protection against incorrect installation of input stages, which can result in overloading of the variable speed drive unit when the input transmission ratio is too high, despite correct engine torque.

It is also possible with the present invention to achieve protection against an increase in the input torque as a result of hydrodynamic converters when there is a malfunction of an electronically produced reduction of the engine torque, as well as preventing additional influences.

The present invention also enables torque-reducing engagement if highly dynamic operating conditions result in excessive torques acting on the variable speed drive unit, which are not noted at the transmission interfaces, for example as a result of shifting processes with angular momentum effects within overall drive trains in power branching.

It is beneficial to store information about load collection points, overloads, and overtorques in a memory of electronic control unit 80, for example an EPROM, so that those data are available for analysis and to prove abuse, for example.

The determination of the torque transmitted by the belt-driven conical-pulley transmission by reading its torque-sensing device, portrayed as an application for limiting the input torque, can also be used for other purposes, so that the Applicant reserves the right to claim the determination of the torque by detecting a value itself set by the torque sensing device.

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within the scope of the present invention.

What is claimed is:

1. A method for limiting the input torque of a belt-driven conical-pulley transmission having a hydromechanical torque sensing device, said method comprising the steps of:
providing a torque-sensing device in a power transmission path extending from an input shaft of the transmission to an output shaft;
controlling as a function of the position of an actuator whose position depends on the torque acting on the input shaft a contact pressure that acts between a conical disk pair of the transmission; and
determining the input torque by detecting a value that is determined by the torque-sensing device.

2. A method in accordance with claim 1, wherein the value determined by the torque sensing device and from which the input torque is determined is the contact pressure set by the torque-sensing device.

3. A method in accordance with claim 1, including the step of taking into account a characteristic curve of the torque sensing device when determining the effective input torque to provide the contact pressure as a function of the instantaneous transmission ratio of the belt-driven conical-pulley transmission.

4. A method in accordance with claim 1, including the step of limiting the input torque to a value that is a function of an operating parameter of the belt-driven conical-pulley transmission.

5. A method in accordance with claim 1, including the step of limiting the input torque as a function of an operating parameter of a drive train containing the belt-driven conical-pulley transmission.

6. A method in accordance with claim 1, including the step of limiting the input torque by limiting a drive torque produced by a drive engine.

7. A method in accordance with claim 1, including the step of limiting the input torque by limiting a torque transmitted by a clutch connected with the belt-driven conical-pulley transmission.

8. Apparatus for limiting the input torque of a belt-driven conical-pulley transmission having hydromechanical torque sensing device, said apparatus comprising:
a torque sensing device contained in a power transmission path from an input shaft of the transmission to an output shaft for controlling a contact pressure acting between a conical disk pair of the transmission as a function of a position of an actuator whose position depends upon a torque acting on the input shaft;
a torque sensor for detecting a value set by the torque-sensing device;
an actuator for setting an input torque of the belt-driven conical-pulley transmission; and
an electronic control unit connected to the torque sensor and to the actuator for controlling the actuator to set the input torque so that a value detected by the torque sensor does not exceed a predetermined value.

9. Apparatus in accordance with claim 8, including additional sensors for detecting operating parameters of a drive train in which the belt-driven conical-pulley transmission is contained, wherein performance characteristics of the transmission dictate a maximum permissible input torque as a function of at least one of the detected operating parameters.

10. Apparatus in accordance with claim 8, including a readable memory element for storing collected values of at least one operating parameter of a drive train containing the belt-driven conical-pulley transmission.
